(19) United States
(12) Patent Application Publication
(10) Pub. No.: US 2020/0284091 A1
(43) Pub. Date: Sep. 10, 2020

(54) MOTORIZED AND AUTOMATED WINDOW SHUTTER WITH SLIP CLUTCH

(71) Applicant: Wideband Labs, LLC, Joplin, MO (US)

(72) Inventors: Jason Turner, Joplin, MO (US); Jared Wilkinson, Joplin, MO (US); Ryan Edward Chacon, Carthage, MO (US); Ethan James Turner, Joplin, MO (US)

(73) Assignee: Wideband Labs, LLC, Joplin, MO (US)

(21) Appl. No.: 16/811,645

(22) Filed: Mar. 6, 2020

Related U.S. Application Data
(60) Provisional application No. 62/814,461, filed on Mar. 6, 2019.

(51) Int. Cl. E06B 9/322; E06B 9/307

(52) U.S. Cl. CPC E06B 9/322; E06B 9/307

(57) ABSTRACT

A motorized and automated shutter with slip clutch provides automated control of positioning of the louvers while allowing manual movement of the louvers without damage to the drive train and without disrupting automated control. A slip clutch assembly in the motorized drive train allows manual movement of the louvers of the shutter without imparting force back into the drive motor. A position sensor monitors the position of the louver and provides a signal to control circuitry to allow synchronization or simultaneous operation of multiple window shutters based on manual movement of a single louver.

### CROSS-REFERENCE TO RELATED APPLICATIONS

This application claims the benefit of U.S. Provisional Patent Application No. 62/814,461, filed Mar. 6, 2019, the disclosure of which is hereby incorporated herein in its entirety by reference.

### BACKGROUND

Motorized window shutters are a convenient and practical accessory for windows, allowing users to selectively open and close the louvers of the shutters as desired. For example, the louvers of shutters on externally facing windows may be fully opened to allow maximum sunlight into a room or area within a building, or the louvers may be partially or fully closed to block direct sunlight into the room or area. Similarly, motorized shutters may be used on window panels within buildings, such as glass panels defining a wall of a conference room to provide privacy or lighting control when the room is in use.

Conventional motorized or automated window shutters do not allow for manual positioning of the louvers. Because the louvers of conventional motorized shutters are connected to a direct drive motor mechanism, manual movement of the louvers typically imparts force back into the motor and drive assembly, often resulting in damage to that assembly.

Furthermore, control systems for automated shutter systems often move multiple shutters simultaneously, e.g., the louvers of all shutters within a defined group are moved to identical corresponding positions. Any manual movement of the louvers of an individual shutter may disrupt the automated control and/or render the manually manipulated shutter out-of-sync with the other shutters in the group.

Typically, conventional motorized window shutters are dependent on existing building wiring to provide AC power either directly to the shutter via a hard-wired or wall plug-in connection, or via a DC converter plugged in to the AC power system. The use of existing wall plug-ins usually necessitates the use of extension cords or wiring which detracts from the aesthetic appearance of the installed shutters. Otherwise, each individual shutter must be located in proximity to a power outlet, or the building wiring must be adapted or extended to provide the required power to each shutter. Some conventional motorized shutters provide for daisy-chaining power wires from one shutter to the next, which requires either modification to building wiring if the electrical wires are to be hidden or requires surface mounting of wires from one shutter to the next, disturbing the aesthetic appearance of the shutter installation.

Thus, it can be seen that there remains a need in the art for motorized and automated shutters that allow for manual control without damage or disruption of automated control, and that do not require building electrical power wiring or outlets and that provide for simple, reliable operation in any mode, whether individually, in groups, or in synchronized operation.

### SUMMARY

Embodiments of the invention are defined by the claims below, not this summary. A high-level overview of various aspects of the invention is provided here to introduce a selection of concepts that are further described in the detailed description section below. This summary is not intended to identify key features or essential features of the claimed subject matter, nor is it intended to be used in isolation to determine the scope of the claimed subject matter. In brief, this disclosure describes, among other things, a motorized and automated window shutter with a slip clutch to allow manual operation with reversion to automated control.

In one aspect, the window shutter of the present invention allows motorized and manual movement of a louver or louvers. In another aspect, the window shutter of the present invention includes a motor and motor drive assembly comprising a slip clutch mechanism that allows the louver shaft to rotate independently of the motor. In another aspect, the window shutter of the present invention includes a louver position sensor that monitors the position of the louvers of the shutter. In a further aspect, the window shutter of the present invention provides communication to allow multiple shutters/louvers to be operated in unison and/or in synchronization. In another aspect, the window shutter of the present invention is powered via internal or external battery or power supply.

In one embodiment, a drive mechanism for a motorized window shutter comprises a slip clutch assembly coupling the drive motor to the shaft of a louver such that the shaft of the louver can be manually moved by overcoming the frictional force of the slip clutch and without imparting force into the drive motor or drive motor assembly.

Thus, the motorized window shutter of the present invention provides louvered shutters that may be controlled in an automated manner using a drive motor, and that may be operated manually without damage to the drive assembly. A louver position sensor provides positional information to a local or remote-control system that allows the control system to detect any manually movement of the louvers and to account for such movement during automated operation such as synchronized or simultaneous operation.

Further exemplary embodiments including internal and external batteries, power-over-ethernet, and solar and inductive charging are disclosed.

### DESCRIPTION OF THE DRAWINGS

Illustrative embodiments of the invention are described in detail below with reference to the attached drawing figures, and wherein:

FIG. 1 is a perspective view of a motorized and automated window shutter with slip-clutch in accordance with an exemplary embodiment of the present invention.

FIG. 2 is a perspective view of a group of motorized and automated window shutters as in FIG. 1 in accordance with an exemplary embodiment of the present invention.

FIG. 3 is a front view of the motor assembly of the motorized and automated window shutter with slip-clutch of FIG. 1.

FIG. 4A is an exploded view of the slip-clutch of the motor assembly of FIG. 3.

FIG. 4B is a partially assembled view of the slip-clutch of FIG. 4A.

FIG. 4C is an assembled view of the slip clutch of FIG. 4A.

FIG. 4D is view of the slip clutch of FIG. 4C installed in the drive assembly housing of FIG. 3.

FIG. 5 is a close-up partial view of a louver of the motorized and automated window shutter with slip clutch of FIG. 1 showing attachment of the louver to the frame.

FIG. 6 is a block diagram of an exemplary network configuration for control and operation of multiple motorized and automated window shutters.

### DETAILED DESCRIPTION

The subject matter of select embodiments of the invention is described with specificity herein to meet statutory requirements. But the description itself is not intended to necessarily limit the scope of claims. Rather, the claimed subject matter might be embodied in other ways to include different components, steps, or combinations thereof similar to the ones described in this document, in conjunction with other present or future technologies. Terms should not be interpreted as implying any particular order among or between various steps herein disclosed unless and except when the order of individual steps is explicitly described. The terms “about” or “approximately” as used herein denote deviations from the exact value in the form of changes or deviations that are insignificant to the function.

Embodiments of the invention include motorized and automated window shutters with slip-clutch that allow motorized and automated control of louver position, that further allow manual operation of the louvers without damage to the drive assembly, and that further detect louver position to allow a control system to detect and account for manual movement of the louvers.

Various embodiments for powering and communicating to window shutters and groups of window shutters are provided, permitting the operation of a single window shutter, groups of window shutters, or multiple groups of window shutters to open and close their louvers according to desired schedules or events, and to achieve simultaneous opening and closing of louvers of multiple shutters and groups of shutters. In addition to the operation of the shutters, alternative embodiments provide for powering the shutters with internal or external batteries or power supplies.

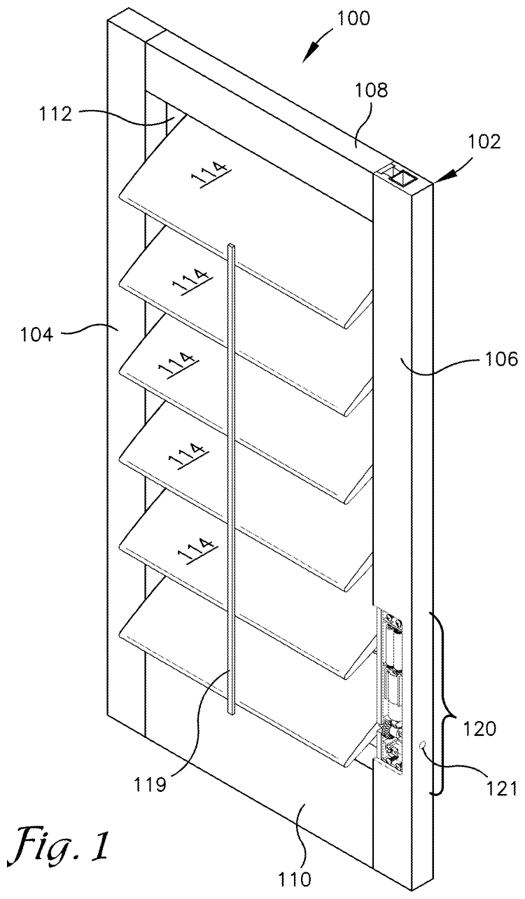

Looking first to FIG. 1, a motorized and automated window shutter with slip clutch in accordance with a first exemplary embodiment of the present invention is designated generally by the numeral 100. The shutter 100 comprises a generally rectangular outer frame assembly 102 comprised of left and right vertical stiles 104, 106 and top and bottom rails 108, 110 defining an interior opening 112. Each of the left and right vertical stiles 104, 106 and top and bottom rails 108, 110 is an elongated, rectangular shaped tube, enclosed on all sides. Preferably, each of the stiles and rails is formed of a strong, rigid material such that when attached together as depicted in FIG. 1, the stiles and rails form a rigid frame assembly 102 for mounting in or to a window frame.

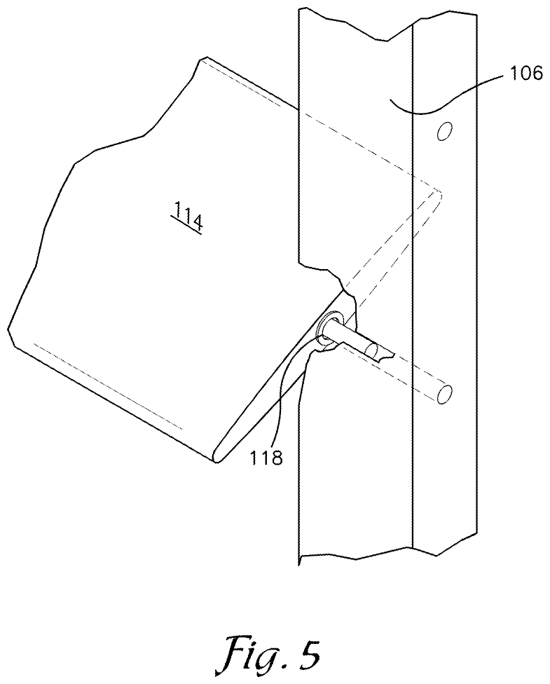

A plurality of horizontal louvers 114 extend across the interior opening 112, positioned at symmetrical vertical intervals to substantially cover the opening. Looking to FIG. 5, a close-up and cutaway view of one of the louvers 114 of FIG. 1, a shaft 116 is attached to, and/or extends from each end of each louver. The shaft extends into a bushing 118 mounted into a corresponding aperture in the vertical stile so that the louver is supported by and can rotate in the bushing. Turning back to FIG. 1, an elongated push rod 119 extends vertically along the front edge of the plurality of louvers and is attached to each louver. Thus, moving the push rod 119—e.g., lifting it upwardly or downwardly—moves the front edge of each louver 114, causing each louver to simultaneously and correspondingly rotate within the interior opening 112. Thus, the plurality of louvers can be positioned between an upper position and a lower position, or to any point therebetween, to cover or reveal the interior opening 112, to allow more or less light or visibility through the window to which the window shutter is attached.

It should be understood that, because the louvers are attached by the push rod, that manually moving any individual louver, e.g., a user grasping a front edge and moving the louver, will move the push rod which will likewise move the other louvers. Thus, manual adjustment of the shutter louvers may be accomplished by using the push rod or by moving any individual louver, with the other louvers following that movement.

A drive assembly 120, described in more detail below, is positioned in the lower portion of the right vertical stile 106, the drive assembly 120 configured to attach to the shaft 116 of the lowest louver to rotate and move the lower louver, and thus all of the louvers. The drive assembly preferably includes a motor to provide motive force to rotate the shaft of the louver, most preferably through a slip clutch assembly. The drive assembly 120 also includes a battery or power supply, control circuitry operable to command the motor to drive the louvers to a desired position, and communication circuitry operable to receive commands to control the louvers and/or to communicate with other window shutters or control units. An aperture 121 is formed in the outer edge of the right vertical stile 106 to allow access to a friction adjustment screw in the drive assembly 120. It should be understood that drive assembly 120 may be mounted in other locations, such as at the upper portion of the stile, midway along the stile, or mounted on the left-hand stile. As will be described in more detail herein, the drive assembly directly drives one of the louvers in the assembly, thus the drive assembly may be mounted adjacent any desired louver, or may be mounted some distance from the louver with a linkage to the louver to be driven.

Bushing 118, and the bushings used to mount all of the louvers in the shutter unit, is preferably a no-friction or very low friction bushing as is known in the art. It should be understood that, as known in the art, manually adjustable shutters typically use at least one frictional bushing per louver so that the louver stays in place after being manually positioned. A typical manually operated shutter thus includes a combination of no-friction and frictional bushings so that the plurality of louvers stays in a desired position after being manually positioned.

Preferably, all of the bushings 118 employed in the window shutter of the present invention are no-friction bushings, with the friction of the drive assembly 120 keeping the louvers in a desired position while still allowing motorized and manual movement of the louvers.

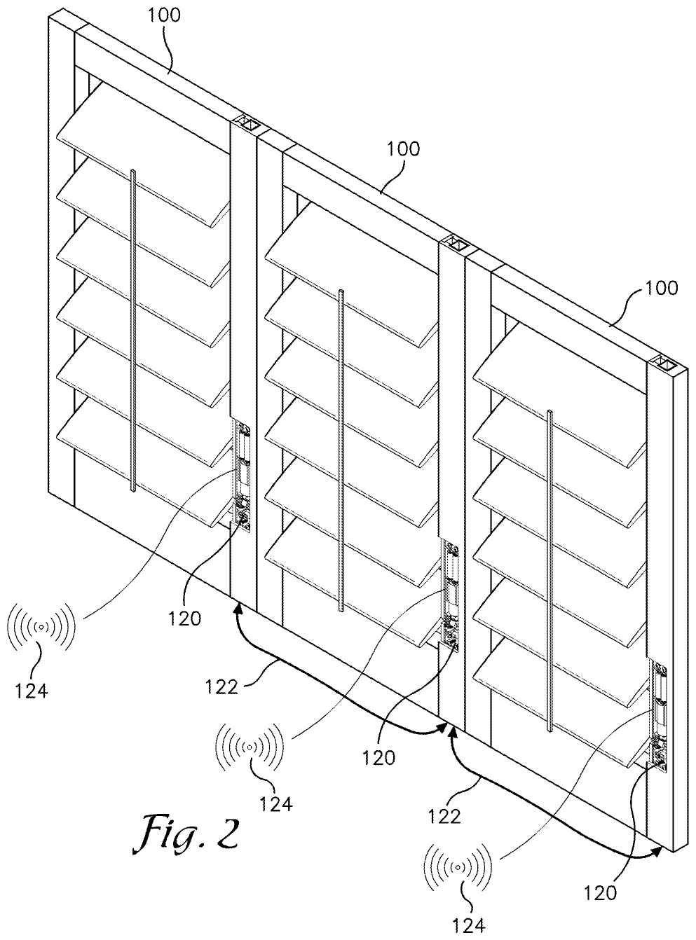

Looking to FIG. 2, a plurality of individual window shutter units 100 are depicted in a manner as would be suitable for placement on side-by-side windows. Each shutter unit includes a drive assembly 120 having control circuitry and a motor operable to move the louvers of the corresponding shutter unit and wired 122 or wireless communication 124 circuitry operable to facilitate communicate between other shutter units and/or with a control system. Thus, for example, all three window shutter units 100 could be individually commanded via a wired or wireless remote control to open or close, or the shutters could be assigned to a common group and that group commanded to open or close simultaneously. Similarly, additional shutters on other windows could be included with the group depicted in FIG. 2. Thus, for example, the shutters in an entire house could be commanded to open or close simultaneously. Other groupings, scenes, and conditions for operation can also be instigated by a controller or a user to operate the shutters individual or in groups as desired. A position sensor in the drive assembly 120 provides positional/rotational information of the louvers to control circuitry within the drive assembly. That positional information, and other control information, may be transmitted via wired 122 or wireless 124 communication to other shutter units and/or to a remote control for the shutters.

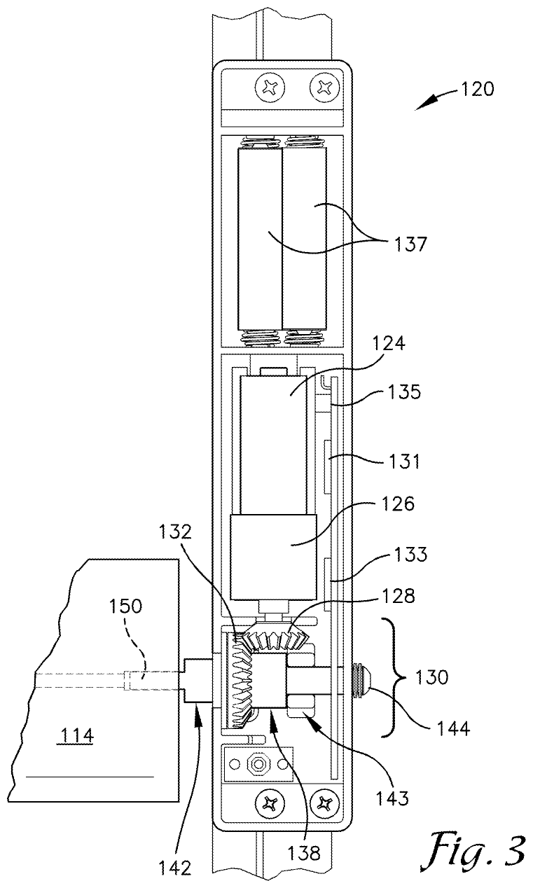

Turning to FIG. 3, the drive assembly 120 includes a drive motor 124 coupled to a gearing unit 126 which in turn is coupled to a first bevel gear 128 such that rotational input from the drive motor 124 to the gearing unit 126 provides a corresponding rotational output of the first bevel gear 128. First bevel gear 128 engages with second bevel gear 132 of a slip-clutch assembly 130.

Gearing unit 126 preferably provides a high ratio gear reduction such that a single rotation of the drive motor 124 input results in a corresponding fractional output rotation of the first bevel gear 128. Power to the drive motor 124 and control circuitry 131 and communications circuitry 133 (contained on circuit board 135) is provided by batteries 137. Preferably, the drive motor 124 and gearing unit 126 individually and in combination provide a relatively high frictional resistance to movement so that once commanded to a desired position, the internal friction of the motor and the drive unit resist casual movement or rotation. Most preferably, the frictional resistance of the motor 124 and gearing unit 126 are greater than the frictional resistance or slip of the slip clutch assembly 130 so that manual movement of a louver will overcome the slip resistance of the slip clutch assembly 130 without imparting movement to the gearing unit 126 or drive motor 124.

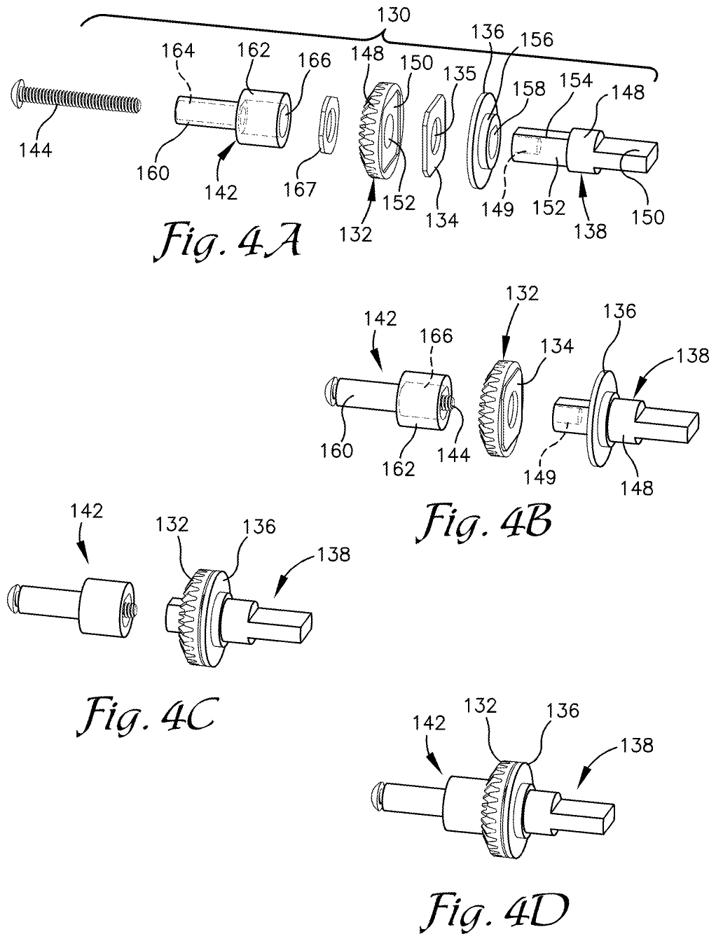

Looking to FIG. 4A, an exploded view of the slip clutch assembly 130 is depicted. Slip clutch assembly 130 includes a second bevel gear 132, a first clutch plate 134, a second clutch plate 136, a louver attachment shaft 138, a low-friction spacer 140, a louver drive shaft 142, and a friction adjustment screw 144.

First clutch plate 134 is generally square shaped, with a round aperture 135 formed therethrough. Second bevel gear 132 comprises a series of external teeth 148 extending circumferentially around the outer perimeter, with a square shaped recessed 150 on one side, the recess configured to receive the first clutch plate 134, and with a round aperture 152 formed therethrough. As seen in FIG. 4B, the first clutch plate 134 fits into the square shaped recess of the second bevel gear 132 so that the round apertures through each are axially aligned. Thus assembled, it is understood that second bevel gear 132 and the first clutch plate 134 rotate in unison, such that rotation of the second bevel gear will likewise rotate the first clutch plate, and vice versa.

Elongate louver attachment shaft 138 comprises a cylindrical center section 148, with a flattened bar 150 extending from one side and a generally cylindrical pin 152 with a flattened surface 154 extending from the opposite side of the center section 148. A threaded socket 149 is formed in the end of cylindrical pin 152, the threaded socket is configured to receive the threaded end of the friction adjustment screw 144 as will be described below.

Disc-shaped second clutch plate 136 comprises a protruding shoulder 156, with a round aperture having a flattened side 158 formed axially therethrough, the aperture 158 configured to receive the cylindrical pin 152 with a flattened surface 154 of the louver attachment shaft 138. When the cylindrical pin 152 with a flattened surface 154 is inserted through the aperture 158 of the second clutch plate as seen in FIG. 4B, the second clutch plate 136 and louver attachment shaft 138 will rotate in unison such that rotation of the second clutch plate 136 will likewise rotate the louver attachment shaft 138, and vice versa. The nominal diameter of the cylindrical pin 152 is smaller than the diameter of the center section 148 so that the center section 148 acts as a shoulder to prevent the louver attachment shaft 138 from passing through the aperture 158 of the second clutch plate 136.

The nominal diameter of the generally cylindrical pin 152 is smaller than the diameter of the apertures 135, 152 in the first clutch plate 134 and second bevel gear 132, respectively, so that the cylindrical pin 152 passes through those apertures without frictional engagement and can rotate freely within without rotating or moving the first clutch plate 134 or second bevel gear 132. Thus, assembled as seen in FIG. 4B, it is understood that the louver attachment shaft 138 and the second clutch plate 136 turn in unison, such that rotation of the louver attachment shaft will likewise rotate the second clutch plate, and vice versa.

Louver drive shaft 142 is a generally elongated, cylindrical shaft, with a smaller diameter first portion 160 and a larger diameter second portion 162, with a smaller diameter tubular aperture 164 extending axially through the first portion 160 of the shaft 142 and a larger diameter tubular aperture having a flattened side 166 extending through the second portion 162. The tubular aperture having a flattened side 166 is configured to receive the correspondingly shaped pin 152 of the louver attachment shaft 138. As seen in FIG. 4B, friction adjustment screw 144 extends through the louver drive shaft 142 so that a threaded portion of the screw 144 extends from the flattened aperture of the larger diameter second portion 162 so that the screw can mate with the threaded socket 149 of the louver drive shaft 138.

A low friction spacer 167 positioned between the louver drive shaft 142 and the second bevel gear 132 prevents frictional engagement between the shaft 142 and gear 132 when assembled as seen in FIG. 4B.

When assembled as seen in FIG. 4B, the louver attachment shaft 142, second clutch plate 136, and louver drive shaft 138 rotate in unison, with the louver drive shaft rotating freely within the apertures in the second bevel gear 132 and first clutch plate 134 as previously described. And, when assembled, the second bevel gear 132 and first clutch plate 134 rotate in unison as previously described.

With reference back to FIG. 4A, when assembled as seen in FIG. 4B, the friction between the mating surfaces of the first clutch plate 134 and the second clutch plate 136 provide a rotational link between the second bevel gear 132/first clutch plate 134 assembly, and the louver attachment shaft 142/second clutch plate 136/louver drive shaft 138 assembly. It should be understood that the frictional engagement, or slip, between the two assemblies can be adjusted via friction screw 144. As the friction screw 144 is tightened into the threaded socket 149, the two clutch plates 134, 136 are pulled more tightly together, thus increasing the friction between the two. As the friction screw 144 is loosened from the threaded socket 149, the friction between the two clutch plates 134, 136 is lessened. Thus, the slip between the two assemblies can be adjusted via the friction screw 144. With reference back to FIG. 1, the head of the friction adjustment screw is preferably accessible through an aperture 121 in the right-hand stile 106 so that the slip of the drive assembly can be adjusted while installed in the shutter unit 100. In other embodiments, other mechanisms for adjusting or maintain the friction between the two clutch plates 134, 136 may be used. For example, a tension spring may be placed against one of the clutch plates to provide a constant bias against the plate, or a mechanism combining a constant bias and an adjustable force may be employed.

Looking to FIG. 3, operation of the slip clutch assembly 130 and the drive assembly 120 of which it is a part will now be described. In the embodiment shown, a rotational position sensor 143 is attached to the louver drive shaft 138. The position sensor 143 is in communication with the control circuitry 131 to provide a signal corresponding to the rotational position of the louver drive shaft 138. As the louver drive shaft 138 rotates, the position sensor 143 likewise rotates so that the actual position of the louver drive shaft (and the louver) is known, regardless of whether the louver was command or moved via the drive motor or whether the louver was moved manually.

For motorized movement of the louver 114, a command from the control circuitry 131 actuates driver motor 124 to move the louver 114 to a desired position as indicated by position sensor 143, or to move the louver in a direction—i.e., up/down open/closed—until commanded to stop. The drive motor 124 drives the gear unit 126 as described above, which in turn drives the first bevel gear 128. The first bevel gear 128 is engaged with and drives the second bevel gear 132 which correspondingly rotates the first clutch plate 132 (refer to FIG. 4A) as described above. The frictional engagement of the first clutch plate 132 with the second clutch plate 136 drives the louver attachment shaft 142 which is attached to the louver 114 via the flattened bar 150 portion inserted into a corresponding slot in the end of the louver 114. Thus, rotational movement of the drive motor 124 is translated to rotational movement of the louver 114 through the gear unit 126 and the slip clutch assembly 130. The position sensor 143 rotates with the louver drive shaft 138 so that the position of the louver and drive shaft can be monitored by the control circuitry 131 as desired. It should be understood that, as described above with respect to FIG. 1, because all of the louvers of the window shutter unit 100 are connected via the push bar 119, that driving a single louver 114 with the motor assembly as just described in fact moves all of the louvers of that unit. As also described above, because the louvers 114 are attached and supported into the frame 102 via low friction bushings 118, the drive motor 124, gearing unit 126, and slip clutch assembly provide the frictional resistance to keep the louvers in their desired position.

Referring to FIG. 3 in conjunction with FIGS. 1 and 4A, for manual movement of the louvers, a user may grasp the pull bar 119, or the edge of any of the individual louvers 114 and move/rotate the louvers to a desired position. That manual movement of the louvers translates rotation into the slip clutch assembly 130 via the louver attachment shaft 142. Because the slip friction/resistance of the slip clutch assembly is less than the frictional resistance of the drive motor 124 and gearing unit 126, any manual movement of the louvers by a user will overcome the slip resistance of the slip clutch assembly, allowing the louver 114, louver attachment shaft 142, and louver drive shaft 138 to rotate in unison, without imparting any movement to the first clutch plate 134 or the second bevel gear 138. Thus, the louver rotates to a desired manual position without imparting any force back into the gearing unit 126 and drive motor 124. Notably, the manual movement of the louver does rotate the louver drive shaft 142 and the attached position sensor 143 so that the position of the louver 114 is detected even though not commanded by the control circuitry 131. Thus upon activation of the control circuitry 131 for manual operation the control circuitry 131 can detect the actual position of the louver 114, even though moved manually and not commanded by the control circuitry, such that operation of the louvers can seamlessly revert to automated operation. Furthermore, upon detection of the change in actual position of the louver 114, the control circuitry 131 of one window shutter unit can communicate with the control circuitry of other window shutter units so those units can be commanded to match the position of the manually moved louver. Thus, an entire house of shutter units may respond to the movement of a single user moving a louver so that all shutters operate in unison, if desired. In an exemplary embodiment, the position sensor 143 is an analog potentiometer which allows the position of the louver 114 to be tracked even when in low or no power mode. In other embodiments, the position sensor may be any type of rotational or position sensor known in the art.

It should be understood that while the exemplary embodiment depicts an orthogonal arrangement of the slip clutch assembly with respect to the drive motor and gearing unit, other configurations are within the scope of the present invention. For example, the drive assembly and gearing unit may be arranged in-line or side by side, with appropriate connection components to accomplish the rotational transfer. Or, the gearing unit may be integral with the drive motor, or the slip clutch assembly may be integrated into the gearing unit or drive motor, or positioned in a different relationship to those components, as long as the slip clutch assembly is in the chain of rotation between the motor and the louver, the arrangement is within the scope of the present invention. Similarly, a drive motor having a high internal friction may be used alone, without a gearing unit. Any configuration of drive motor, with or without a gearing unit may be used in conjunction with the slip clutch assembly of the present invention. In general, as long as the manual input force is greater than the force required to drive a louver and that force is less than the frictional force in the slip clutch assembly, the slip clutch assembly of the present invention will allow manual positioning of the louvers as described herein.

In other alternative embodiments, power may be supplied to the shutter units via internal or external batteries. In further embodiments, power may be supplied via ethernet cables, with internal batteries of the shutter units trickle charging from the power-over-ethernet system. And, the ethernet cables can provide the wired communication 122 as discussed above and depicted in FIG. 3.

Most preferably, the logic and control circuitry 131 is configured to communicate with a local or cloud-based server using standard TCP/IP protocols, such as via standard TCP or UDP ports. In an exemplary embodiment, the logic and control circuitry of the shutter establishes communication to a server using Domain Name System (DNS) protocol, allowing each of multiple individual motorized shutter units to communicate to either a local or cloud-based server without user interaction.

Preferably, each shutter unit 100 will establish communication to the cloud server using TCIP-IP communication and the MQTT protocol via wired 122 or wireless 124 communication. Shutter unites preferably publish and subscribe to necessary information to and from the server as required. Each motorized window shutter is preferably able to operate in low energy and low bandwidth modes to minimize communication with the server.

In exemplary embodiments, each motorized window shutter is assigned an IP address and DNS server address location via a standard DHCP protocol. DNS servers such as Google's® public DNS server could be used, allowing the shutters to communicate with a host cloud server. In other exemplary embodiments, a local DHCP server is used and assigns addresses to the shutters using standard DHCP and domain name resolution protocols. Use of a local server acts to reduces the traffic to a cloud server as information is transmitted only within the local network.

In other embodiments, the logic and control circuitry of the window shutter unit includes whitelist capability defining specific IP addresses from which the logic and control circuitry will accept communications, restricting access by unauthorized addresses, and preventing unauthorized control of the shutter. Preferably, the whitelist addresses are preconfigured during commission or installation of the shutter or are downloaded by an authorized user of the shutter into the non-volatile memory of the logic and control circuitry.

The logic and control circuitry preferably includes a microprocessor, microcontroller, or other logic executing circuity operable to perform programmed steps or commands, and includes logic and/or instructions for executing bootstrap protocol (BOOTP) to allow individual motorized window shutters to autonomously and dynamically configure communication without user supervision or action. The use of bootstrap protocol allows centralized management of network addresses, eliminating the need for separate, per-host, unique configuration files. Other protocols, such as UPnP (universal plug and play), SDDP (simple device discovery protocol), and SSDP (simple service discovery protocol) may also be used.

The logic and control circuitry 131 preferably includes non-volatile memory that stores various shutter and configuration parameters, including limits, memory positions, speed, schedules, server hostname, network statistics, and other operational and physcial parameters. Most preferably the stored parameters allow the logic and control circuity to operate the shutter autonomously in cases where network communication to the local or cloud server is interrupted. Clock circuitry within the logic and control circuitry allows the shutter to continue to operate according to preprogrammed schedules without connection or initiation from a central server. Preferably, the clock circuity synchronizes with a master clock on a local or cloud-based server periodically so that multiple motorized and automated window shutter with slip clutchs rely on, and update based on, a common clock signal. Information from the shutter may likewise be sent over the network to a local or cloud-based server for storage, aggregation, or use by the server. Thus, a shutter's position or operational status may be relayed to the server periodically, historical performance data of the shutter may be stored, and information about the shutter may be sent to users in communication with the server, for example, to monitor whether a shutter is open or closed.

Most preferably, an individual shutter's parameters are pre-configured by storing information in the non-volatile memory of the logic and control circuitry during the manufacturing process so that a shutter arrives on site ready to install, with no further field configuration required. In addition to the parameters listed above, the pre-configured shutter parameters may include physical or environmental attributes such as room location, dimensions, color, and type. Preferably, the parameters are entered via a web application by a customer or sales representative and transferred to manufacturing servers for use during manufacturing of the shutters. Thus, the shutters arrive on-site set-up and ready to install.

In operation, a shutter is operated by providing a command over the wired or wireless communication network to open or close the louvers or move the louvers to a desired position. In exemplary embodiments, the command may be issued from a computer device connected to the control network, or may be relayed to the network though a local or cloud-based server. In other embodiments, a handheld smart device in communication with the local or cloud-based server may be used to issue commands to control individual shutters. Software on the shutter and/or on the server may also define groups of shutters that can be operated in unison and may define scenes which operate various shutters or groups of shutters in desired sequences. For example, an open command may be issued to an individual shutter or to a group of shutters simultaneously. A scene may define that a first group of shutters is opened, followed by a second group of shutters, and then a third group, and so forth.

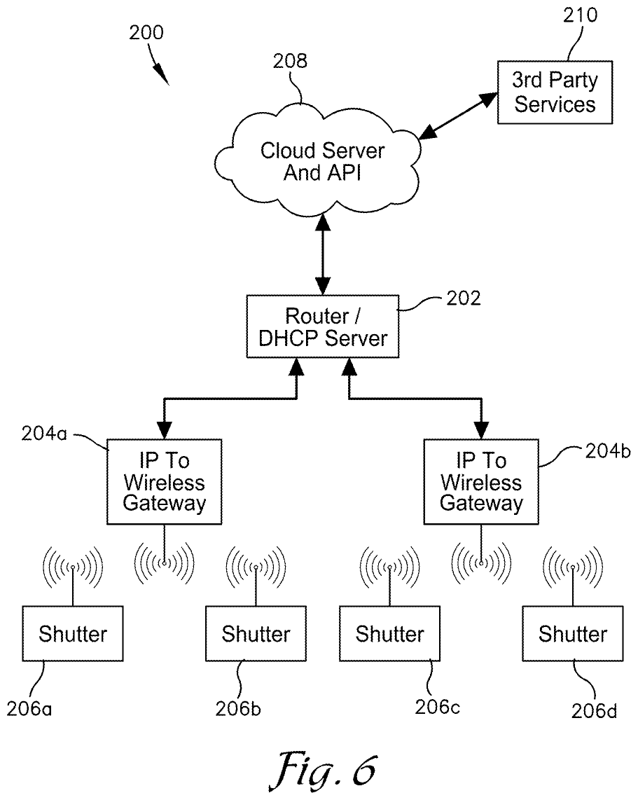

Turning to FIG. 6, a block diagram of an exemplary network for controlling multiple motorized and automated window shutters with slip clutch such as shutter 100 just described, is depicted generally as numeral 200. The network 200 is preferably a wired, wireless, or power over Ethernet (POE) network providing communication and/or power capability as previously described and as known in the art.

Network 200 comprises a router/DHCP server 202 connected to a plurality of IP to wireless gateways 204a, 204b, with a plurality of motorized shutters 206a, 206b, 206c, 206d, connected to the switches 204a, 204b via wireless connection. In alternative embodiments, the connection may be wired. Router 202 is in communication with a cloud server and API 208 which allows third party services 210 to communicate with the cloud server 208 to send commands to the network-connected shutters 206a, 206b, 206c, 206d via the router 202. Third party services may include various smart home and convenience control devices such as Amazon's® Echo® device, SmartThings controllers, IFTTT application, and other control devices including handheld smart devices such as smartphones, tablets, and computers.

The configuration and arrangement of network 200 shown is exemplary in nature and variations and other configurations of connecting the router 202, switches 204a, 204b, and shutters 206a, 206b, 206c, 206d will be apparent to those skilled in the art, such as a network having one or more hardwired control devices. In other embodiments, router 202 may be configured on a local network with a local server and provide a local Wi-Fi interface.

It should be understood that while commands to open and close or otherwise move the louvers are triggered by commands received over the network, the operation of the individual shutter units occurs autonomously within each individual shutter, even within a group of shutters. Thus, while a command to open the shutter may be issued to a group of shutters and is sent to the multiple IP addresses corresponding to those shutters, the actual raise operation occurs within the logic and control circuitry of each of the individual shutters and is not controlled or otherwise coordinated in real time by the server. And, it should be further understood that events may also be, or may alternatively be, initiated by the individual shutter based on a downloaded schedule or other timed event, or may be initiated by one or more external sensors attached to the shutter.

In alternative embodiments, each shutter, or any individual shutter within a group of shutters, may include a local switch allowing operation of the shutter via a physical control switch placed in proximity to the shutter. The switch may be hardwired into the logic and control circuitry via the externally available conductors, or may be wired to the network with commands sent to the desired shutter.

In further embodiments, a motorized and automated window shutter with slip clutch in accordance with the present invention is commissioned, installed, or setup via a mobile application running on a mobile smart device, such as an iOS or Android device. For example, an installer will download an application on his or her phone that allows the configuration of the shutter, the shutter name, and assign the shutter to a group, scene, or assign schedules using the application. Most preferably, data collected via the mobile application during shutter commissioning will further be uploaded and stored to the cloud for use in statistical analysis, customer support, service, and warranty purposes.

In other embodiments, motorized and automated window shutters may be operated by a user using a mobile application running on a smart device so that shutters may be moved to position, or opened and closed as desired. Preferably a user of the mobile application assign shutter names, assign groups, assign scenes, and assign schedules by using the application, and can receive notifications of shutter activity through the application.

In alternative embodiments, the motorized and automated window shutter is controlled via a radio-frequency Gateway, with functionality substantially the same as that just described with respect to the network.

In further exemplary embodiments, near field communication, BLE proximity profile, or other wireless communication identification technologies may be used to automatically initiate a command to activate shutter operation according to predefined groups or according to scenes defining a desired operation of multiple shutters. Other technologies may similarly be employed to allow operation of the shutters based on facial recognition, voice commands, and detection of other parameters, such as light levels in the room. Control via those various sensors preferably occurs over the network as described above.

From the above, it can be seen that the motorized and automated window shutter with slip clutch of the present invention is well-suited to provide automated motorized control of the window shutter while also allowing manual operation of the shutter without causing damage to the motor or drive assembly, and without disrupting automated and synchronized control of the shutter.

While the motorized and automated window shutter with slip clutch of the present invention have been described herein with respect to specific embodiments, many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Identification of structures as being configured to perform a particular function in this disclosure and in the claims below is intended to be inclusive of structures and arrangements or designs thereof that are within the scope of this disclosure and readily identifiable by one of skill in the art and that can perform the particular function in a similar way. Certain features and sub-combinations are of utility and may be employed without reference to other features and sub-combinations and are contemplated within the scope of the claims.

What is claimed is:

1. A motorized and automated shutter, comprising:
a plurality of interconnected movable louvers mounted in a frame;
a drive motor assembly comprising a drive motor and a slip clutch assembly, wherein the drive motor assembly is coupled to at least one of the plurality of movable louvers to provide motorized movement of the louvers, and wherein the slip clutch assembly permits manual movement of the louvers without imparting force to the drive motor.

2. The motorized and automated shutter of claim 1, wherein the louvers are pivotably attached to the frame with low friction bushings.

3. The motorized and automated shutter of claim 1, wherein the slip clutch assembly comprises:
a first clutch plate comprising a first frictional surface;
a second clutch plate comprising a second frictional surface, wherein the second frictional surface is positioned in contact with the first frictional surface such that rotation of the first clutch plate with respect to the second clutch plate requires a force greater than the frictional coefficient between the two clutch plates.

4. The motorized and automated shutter of claim 3, further comprising:
an adjustment mechanism coupled to the first clutch plate, the adjustment mechanism operable to move the first clutch plate with respect to the second clutch plate to increase or decrease the friction between the first frictional surface and the second frictional surface.

5. The motorized and automated shutter of claim 3, wherein the frictional resistance between the first and second clutch plates is less than the frictional resistance of the drive motor.

6. The motorized and automated shutter of claim 1, further comprising a gearing assembly coupled between the drive motor and the slip clutch assembly, the gearing assembly comprising reduction gears such that rotation of an input of the gearing assembly results in a corresponding fractional rotation of an output of the gearing assembly.

7. The motorized and automated shutter of claim 1, further comprising a position sensor coupled to the drive motor assembly, wherein the position sensor provides an output signal indicative of a position of one of the louvers.

8. The motorized and automated shutter of claim 8, further comprising communication and control circuitry to transmit the output signal indicating a position of one of the louvers.

9. The motorized and automated shutter of claim 1, further comprising an internal battery for providing power to the drive motor and internal circuitry of the shutter.

10. A drive assembly for a motorized and automated shutter, comprising:
a drive motor;
a slip clutch assembly coupled to a rotational output of the drive motor, wherein the slip clutch assembly is configured to attach to and rotate a louver of the automated shutter and to permit manual movement of the louver without imparting force to the drive motor.

11. The drive assembly of claim 10, wherein the slip clutch assembly comprises:
a first clutch plate comprising a first frictional surface;
a second clutch plate comprising a second frictional surface, wherein the second frictional surface is positioned in contact with the first frictional surface such that rotation of the first clutch plate with respect to the second clutch plate requires a force greater than the frictional coefficient between the two clutch plates.

12. The drive assembly of claim 11, further comprising:
an adjustment mechanism coupled to the first clutch plate, the adjustment mechanism operable to move the first clutch plate with respect to the second clutch plate to increase or decrease the friction between the first frictional surface and the second frictional surface.

13. The drive assembly of claim 11, wherein the frictional resistance between the first and second clutch plates is less than the frictional resistance of the drive motor.

14. The drive assembly of claim 10, further comprising a gearing assembly coupled between the drive motor and the slip clutch assembly, the gearing assembly comprising reduction gears such that rotation of an input of the gearing assembly results in a corresponding fractional rotation of an output of the gearing assembly.

15. The drive assembly of claim 10, further comprising a position sensor coupled to the drive motor assembly, wherein the position sensor provides an output signal indicative of a position of an output of the slip clutch assembly.

16. The drive assembly of claim 10, further comprising communication and control circuitry to transmit the output signal.

17. The drive assembly of claim 10, further comprising an internal battery for providing power to the drive motor and internal circuitry.

18. A method for manual movement of motorized and automated window shutters, comprising:
providing a plurality of motorized and automated window shutters of claim 1, wherein each of the plurality of motorized and automated window shutters further comprises control and communication circuitry operable to actuate the motor and to communicate over a network to receive commands indicative of a desired operation of the respective shutter;
manually moving a louver of at least one of the plurality of motorized and automated window shutters; and
transmitting a command over the network to each of the plurality of window shutters, the command comprising a detected position of the manually moved louver.
